(19) United States
(12) Patent Application Publication
(10) Pub. No.: US 2023/0296097 A1
(43) Pub. Date: Sep. 21, 2023

(54) Modulated Compressor And Valve Assembly

(71) Applicant: Emerson Climate Technologies, Inc., Sidney, OH (US)

(72) Inventors: Brandon H. BERCOT, Piqua, OH (US); Dennis D. PAX, Piqua, OH (US); Brian J. KNAPKE, Troy, OH (US); Ramesh Chandra BEHERA, Pune (IN); Saurabh PRABHAKAR, Pune (IN); Kamendra SINGH, Pune (IN); Bhagwat Vaijanath NAGURE, Pune (IN); Vinod Arun KOKATE, Pune (IN)

(73) Assignee: Emerson Climate Technologies, Inc., Sidney, OH (US)

(21) Appl. No.: 17/835,048

(22) Filed: Jun. 8, 2022

(30) Foreign Application Priority Data
Mar. 16, 2022 (IN) 202221014366

(51) Int. Cl. F04C 29/12; F04C 18/02

(52) U.S. Cl. CPC F04C 29/124; F04C 18/0215

(57) ABSTRACT

A compressor may include a shell assembly, first and second scrolls, a floating seal assembly, a modulation-valve ring, and a modulation-control-valve assembly. The shell assembly may define a suction-pressure region. The first scroll may include a discharge passage, a modulation port, and a biasing passage. The modulation-valve ring may cooperate with the floating seal assembly and the first scroll to define an axial-biasing chamber in fluid communication with the biasing passage. The modulation-valve ring may be axially displaceable between a closed position to close the modulation port and an open position to open the modulation port. The modulation-control-valve assembly may be mounted to the modulation-valve ring and may be movable between a first position corresponding to the closed position and a second position corresponding to the open position.

### CROSS-REFERENCE TO RELATED APPLICATIONS

This application claims the benefit and priority of Indian Patent Application No. 202221014366, filed Mar. 16, 2022. The entire disclosure of the above application is incorporated herein by reference.

### FIELD

The present disclosure relates to a modulated compressor and a valve assembly for the compressor.

### BACKGROUND

This section provides background information related to the present disclosure and is not necessarily prior art.

A climate-control system (e.g., a heat-pump system, a refrigeration system, or an air conditioning system) may include a fluid circuit having an outdoor heat exchanger, an indoor heat exchanger, an expansion device disposed between the indoor and outdoor heat exchangers, and one or more compressors circulating a working fluid (e.g., refrigerant or carbon dioxide) between the indoor and outdoor heat exchangers. Efficient and reliable operation of the one or more compressors is desirable to ensure that the climate-control system in which the one or more compressors are installed is capable of effectively and efficiently providing a cooling and/or heating effect on demand. The one or more compressors can include a capacity-modulation assembly operable to modulate the capacity of the one or more compressors.

### SUMMARY

This section provides a general summary of the disclosure and is not a comprehensive disclosure of its full scope or all of its features.

In one form, the present disclosure provides a compressor that may include a shell assembly, a first scroll, a second scroll, a floating seal assembly, a modulation-valve ring, and a modulation-control-valve assembly. The shell assembly may define a suction-pressure region and a discharge-pressure region. The shell assembly may include a partition separating the suction-pressure region from the discharge-pressure region. The first scroll may be disposed within the shell assembly and may include a first end plate having a discharge passage, a modulation port, a biasing passage, and a first spiral wrap extending from the first end plate. The second scroll may be disposed within the shell assembly and may include a second end plate having a second spiral wrap extending therefrom. The first and second spiral wraps may be meshingly engaged with each other and form a series of pockets during orbital displacement of the second scroll relative to the first scroll. The modulation port may be in communication with a first one of the pockets. The biasing passage may be in communication with a second one of the pockets. The floating seal assembly may be engaged with the partition and the first scroll and may isolate the discharge-pressure region from the suction-pressure region. The modulation-valve ring may be located axially between the floating seal assembly and the first end plate. The modulation-valve ring may cooperate with the floating seal assembly and a hub extending from the first end plate to define an axial-biasing chamber in fluid communication with the biasing passage. The modulation-valve ring may be axially displaceable between a closed position and an open position. The modulation-valve ring may abut the first end plate and close the modulation port when in the closed position. The modulation-valve ring may be spaced apart from the first end plate to open the modulation port when in the open position.

In some configurations of the compressor of the above paragraph, the modulation-control-valve assembly may be mounted to the modulation-valve ring and may be movable between a first position corresponding to the closed position and a second position corresponding to the open position.

In some configurations of the compressor of either of the above paragraphs, the modulation-valve ring may include a first passage, a second passage, and a third passage.

In some configurations of the compressor of the above paragraph, the second passage may be in fluid communication with the axial-biasing chamber.

In some configurations of the compressor of any of the above paragraphs, the third passage may be in fluid communication with a modulation-control chamber defined by the modulation-valve ring.

In some configurations of the compressor of any of the above paragraphs, the first passage may provide fluid communication between the second and third passages when the modulation-control-valve assembly is in the second position.

In some configurations of the compressor of any of the above paragraphs, the modulation-control-valve assembly prevents fluid communication between the second and third passages when in the first position.

In some configurations of the compressor of any of the above paragraphs, in the first position, the modulation-control-valve assembly allows fluid communication between the modulation-control chamber and the suction-pressure region.

In some configurations of the compressor of any of the above paragraphs, in the first position, the modulation-control-valve assembly allows fluid communication between the modulation-control chamber and the suction-pressure region via the third passage, the first passage, and an aperture in a valve body of the modulation-control-valve assembly.

In some configurations of the compressor of any of the above paragraphs, the modulation-control-valve assembly prevents fluid flow through the aperture in the valve body when the modulation-control-valve assembly is in the second position.

In some configurations of the compressor of any of the above paragraphs, the modulation-control-valve assembly includes a valve body, a valve member, and a plug body.

In some configurations of the compressor of any of the above paragraphs, the valve body and the plug body are fixed relative to the modulation-valve ring.

In some configurations of the compressor of any of the above paragraphs, the valve member is partially disposed within the valve body and movable therein between the first and second positions.

In some configurations of the compressor of any of the above paragraphs, a first portion of the valve member (e.g., a stem of the valve member) extends through the plug body and into the first passage.

In some configurations of the compressor of any of the above paragraphs, the first portion of the valve member closes the second passage when the modulation-control-valve assembly is in the first position.

In some configurations of the compressor of any of the above paragraphs, a second portion of the valve member (e.g., a block of the valve member) closes an aperture in the valve body when the modulation-control-valve assembly is in the second position.

In some configurations of the compressor of any of the above paragraphs, the valve member allows fluid communication between the modulation-control chamber and the suction-pressure region through the aperture when the modulation-control-valve assembly is in the first position.

In some configurations of the compressor of any of the above paragraphs, the first portion of the valve member includes a deflector configured to direct debris into the modulation-control chamber.

In some configurations of the compressor of any of the above paragraphs, the first portion of the valve member extends through a screen that restricts the flow of debris into the modulation-control-valve assembly.

In some configurations of the compressor of any of the above paragraphs, the plug body includes a tapered end portion configured to direct debris into the modulation-control chamber.

In some configurations of the compressor of any of the above paragraphs, the first portion of the valve member includes a barbed tip that closes the second passage when the modulation-control-valve assembly is in the first position.

In some configurations of the compressor of any of the above paragraphs, the second passage is angled relative to an axial length of the first portion of the valve member.

In some configurations of the compressor of any of the above paragraphs, the modulation-control-valve assembly includes a coil that extends around the valve body.

In some configurations of the compressor of any of the above paragraphs, energizing the coil causes the second portion of the valve member to be magnetically attracted to the plug body, which causes movement of the valve member toward the first position.

In some configurations of the compressor of any of the above paragraphs, when the modulation-control-valve assembly is in the second position, fluid flows from the axial-biasing chamber to the modulation-control chamber without flowing through the modulation-control-valve assembly.

In some configurations of the compressor of any of the above paragraphs, when the modulation-control-valve assembly is in the first position, fluid flows through the modulation-control-valve assembly from the modulation-control chamber to the suction-pressure region.

In another form, the present disclosure provides a compressor that may include a shell assembly, a first scroll, a second scroll, a floating seal assembly, a modulation-valve ring, and a modulation-control-valve assembly. The shell assembly may define a suction-pressure region. The first scroll may be disposed within the shell assembly and may include a first end plate having a discharge passage, a modulation port, a biasing passage, and a first spiral wrap extending from the first end plate. The second scroll may be disposed within the shell assembly and may include a second end plate having a second spiral wrap extending therefrom. The first and second spiral wraps are meshingly engaged with each other and form a series of pockets. The modulation port may be in communication with a first one of the pockets. The biasing passage may be in communication with a second one of the pockets. The floating seal assembly may be engaged with the first scroll and may isolate the suction-pressure region from discharge-pressure working fluid. The modulation-valve ring may be engaged with the first scroll and may cooperate with the floating seal assembly and the first scroll to define an axial-biasing chamber in fluid communication with the biasing passage. The modulation-valve ring may be axially displaceable between a closed position and an open position. The modulation-valve ring may abut the first end plate and close the modulation port when in the closed position. The modulation-valve ring may be spaced apart from the first end plate to open the modulation port when in the open position.

In some configurations of the compressor of the above paragraph, the modulation-control-valve assembly may be mounted to the modulation-valve ring and may be movable between a first position corresponding to the closed position and a second position corresponding to the open position.

In some configurations of the compressor of either of the above paragraphs, the modulation-valve ring may include a first passage, a second passage, and a third passage.

In some configurations of the compressor of the above paragraph, the second passage may be in fluid communication with the axial-biasing chamber.

In some configurations of the compressor of any of the above paragraphs, the third passage may be in fluid communication with a modulation-control chamber defined by the modulation-valve ring.

In some configurations of the compressor of any of the above paragraphs, the first passage may provide fluid communication between the second and third passages when the modulation-control-valve assembly is in the second position.

In some configurations of the compressor of any of the above paragraphs, when the modulation-control-valve assembly is in the second position, fluid flows from the axial-biasing chamber to the modulation-control chamber without flowing through the modulation-control-valve assembly.

In some configurations of the compressor of any of the above paragraphs, fluid flows from the axial-biasing chamber to the modulation-control chamber by flowing through only the first, second, and third passages.

In some configurations of the compressor of any of the above paragraphs, when the modulation-control-valve assembly is in the first position, fluid flows through the modulation-control-valve assembly from the modulation-control chamber to the suction-pressure region.

In some configurations of the compressor of any of the above paragraphs, the modulation-control-valve assembly prevents fluid communication between the second and third passages when in the first position.

In some configurations of the compressor of any of the above paragraphs, in the first position, the modulation-control-valve assembly allows fluid communication between the modulation-control chamber and the suction-pressure region.

In some configurations of the compressor of any of the above paragraphs, in the first position, the modulation-control-valve assembly allows fluid communication between the modulation-control chamber and the suction-pressure region via the third passage, the first passage, and an aperture in a valve body of the modulation-control-valve assembly.

In some configurations of the compressor of any of the above paragraphs, the modulation-control-valve assembly prevents fluid flow through the aperture in the valve body when the modulation-control-valve assembly is in the second position.

In some configurations of the compressor of any of the above paragraphs, the modulation-control-valve assembly includes the valve body, a valve member, and a plug body.

In some configurations of the compressor of any of the above paragraphs, the valve body and the plug body are fixed relative to the modulation-valve ring.

In some configurations of the compressor of any of the above paragraphs, the valve member is partially disposed within the valve body and movable therein between the first and second positions.

In some configurations of the compressor of any of the above paragraphs, a first portion of the valve member extends through the plug body and into the first passage.

In some configurations of the compressor of any of the above paragraphs, the first portion of the valve member closes the second passage when the modulation-control-valve assembly is in the first position.

In some configurations of the compressor of any of the above paragraphs, a second portion of the valve member closes an aperture in the valve body when the modulation-control-valve assembly is in the second position.

In some configurations of the compressor of any of the above paragraphs, the valve member allows fluid communication between the modulation-control chamber and the suction-pressure region through the aperture when the modulation-control-valve assembly is in the first position.

In some configurations of the compressor of any of the above paragraphs, the first portion of the valve member includes a deflector configured to direct debris into the modulation-control chamber.

In some configurations of the compressor of any of the above paragraphs, the first portion of the valve member extends through a screen that restricts the flow of debris into the modulation-control-valve assembly.

In some configurations of the compressor of any of the above paragraphs, the plug body includes a tapered end portion configured to direct debris into the modulation-control chamber.

In some configurations of the compressor of any of the above paragraphs, the first portion of the valve member includes a barbed tip that closes the second passage when the modulation-control-valve assembly is in the first position.

In some configurations of the compressor of any of the above paragraphs, the second passage is angled relative to an axial length of the first portion of the valve member.

In some configurations of the compressor of any of the above paragraphs, the modulation-control-valve assembly includes a coil that extends around the valve body.

In some configurations of the compressor of any of the above paragraphs, energizing the coil causes the second portion of the valve member to be magnetically attracted to the plug body, which causes movement of the valve member toward the first position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a compressor having a capacity-modulation assembly according to the principles of the present disclosure;

FIG. 2 is an exploded view of a compression mechanism, floating seal assembly, and the capacity-modulation assembly of the compressor of FIG. 1;

FIG. 3 is a cross-sectional view of a portion of the compressor with the capacity-modulation assembly in reduced-capacity mode;

FIG. 4 is a cross-sectional view of a portion of the compressor with the capacity-modulation assembly in high-capacity mode;

FIG. 5 is a cross-sectional view of a modulation-control-valve assembly of the capacity-modulation assembly in a first position corresponding to the high-capacity mode;

FIG. 6 is a cross-sectional view of a modulation-control-valve assembly of the capacity-modulation assembly in a second position corresponding to the reduced-capacity mode;

FIG. 7 is a perspective view of the modulation-control-valve assembly mounted on a modulation-valve ring of the capacity-modulation assembly;

FIG. 8 is a partially exploded view of the modulation-control-valve assembly;

FIG. 9 is a cross-sectional view of the modulation-control-valve assembly mounted on the modulation-valve ring;

FIG. 10 is a cross-sectional view of another modulation-control-valve assembly;

FIG. 11 is a cross-sectional view of yet another modulation-control-valve assembly;

FIG. 12 is a cross-sectional view of still another modulation-control-valve assembly;

FIG. 13 is a cross-sectional view of yet another modulation-control-valve assembly;

FIG. 14 is a cross-sectional view of yet another modulation-control-valve assembly;

FIG. 15 is a cross-sectional view of yet another modulation-control-valve assembly;

FIG. 16 is a cross-sectional view of a modulation-control-valve assembly mounted to an alternative modulation-valve ring;

FIG. 17 is a perspective view of another modulation-control-valve assembly mounted on a modulation-valve ring of the capacity-modulation assembly; and

FIG. 18 is a partially exploded view of the modulation-control-valve assembly of FIG. 17.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

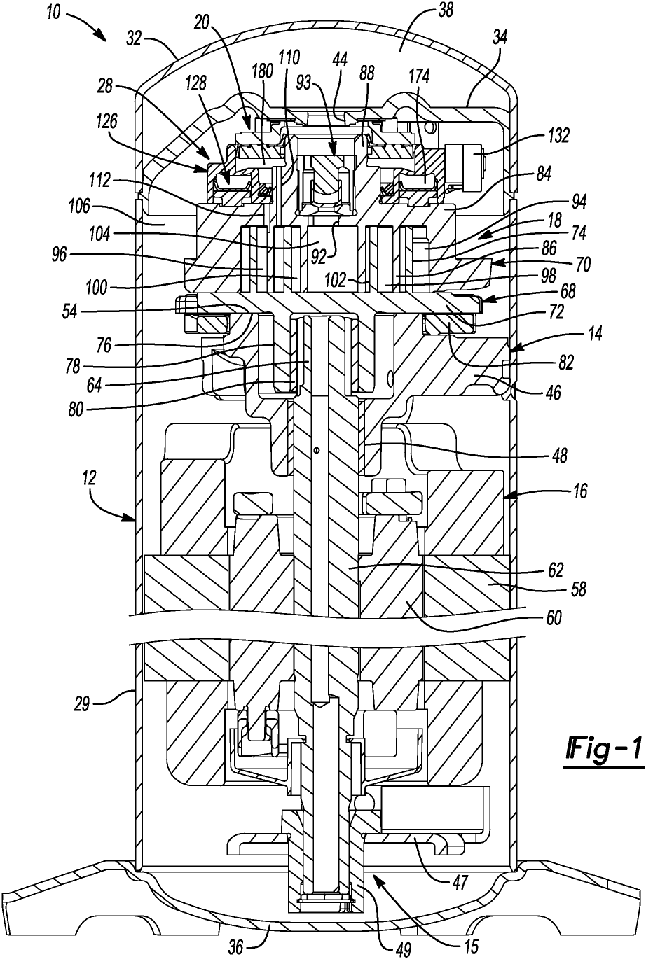

With reference to FIG. 1, a compressor 10 is provided that may include a hermetic shell assembly 12, a first bearing housing assembly 14, a second bearing housing assembly 15, a motor assembly 16, a compression mechanism 18, a seal assembly 20, and a capacity-modulation assembly 28. The shell assembly 12 may house the bearing housing assemblies 14, 15, the motor assembly 16, the compression mechanism 18, the seal assembly 20, and the capacity-modulation assembly 28. As will be described in more detail below, the capacity-modulation assembly 28 may be operable to switch operation of the compressor 10 between a high-capacity mode (e.g., a full-capacity mode) and a low-capacity mode (e.g., a reduced-capacity mode).

The shell assembly 12 may generally form a compressor housing and may include a cylindrical shell 29, an end cap 32 at the upper end thereof, a transversely extending partition 34, and a base 36 at a lower end thereof. The end cap 32 and partition 34 may generally define a discharge chamber 38. The discharge chamber 38 may generally form a discharge muffler for compressor 10. While FIG. 1 shows the compressor 10 including the discharge chamber 38, the principles of the present disclosure apply equally to direct-discharge configurations. A discharge fitting may be attached to the shell assembly 12 at an opening in the end cap 32. A suction-gas-inlet fitting may be attached to the shell assembly 12 at another opening. The partition 34 may include a discharge passage 44 therethrough providing communication between the compression mechanism 18 and the discharge chamber 38.

The first bearing housing assembly 14 may include a first bearing housing 46 and a first bearing 48 disposed within the first bearing housing 46. The first bearing housing 46 may be fixed to the shell 29 and may define an annular flat thrust bearing surface 54. The second bearing housing assembly 15 may include a second bearing housing 47 and a second bearing 49 disposed within the second bearing housing 47. The second bearing housing 47 may be fixed to the shell 29.

The motor assembly 16 may generally include a motor stator 58, a rotor 60, and a driveshaft 62. The motor stator 58 may be fixed relative to the shell 29. The driveshaft 62 may be rotatably driven by the rotor 60 and may be rotatably supported within the bearings 48, 49. The rotor 60 may be fixed to the driveshaft 62. The driveshaft 62 may include an eccentric crankpin 64.

The compression mechanism 18 may include an orbiting scroll 68 and a non-orbiting scroll 70. The orbiting scroll 68 may include an end plate 72 having a spiral wrap 74 on the upper surface thereof and an annular flat thrust surface 76 on the lower surface. The thrust surface 76 may interface with the annular flat thrust bearing surface 54 on the first bearing housing 46. A cylindrical hub 78 may project downwardly from the thrust surface 76 and may have a drive bushing 80 rotatably disposed therein. The drive bushing 80 may include an inner bore in which the crankpin 64 is drivingly disposed. A flat surface of the crankpin 64 may drivingly engage a flat surface in a portion of the inner bore of the drive bushing 80 to provide a radially compliant driving arrangement. An Oldham coupling 82 may be engaged with the orbiting and non-orbiting scrolls 68, 70 or the orbiting scroll 68 and the first bearing housing 46 to prevent relative rotation between the orbiting and non-orbiting scrolls 68, 70.

The non-orbiting scroll 70 may include an end plate 84 having a spiral wrap 86 extending from a first side 87 thereof and an annular hub 88 extending from a second side 89 thereof opposite the first side. The spiral wraps 74, 86 may be meshingly engaged with one another defining moving compression pockets 94, 96, 98, 100, 102, 104. The end plate 84 defines a discharge passage 92 in communication with the pocket 104.

A first pocket (e.g., pocket 94) may define a suction pocket in communication with a suction-pressure region 106 of the compressor 10 operating at a suction pressure and a second pocket (e.g., pocket 104) may define a discharge pocket in communication with a discharge pressure region (e.g., discharge chamber 38 and/or any other space operating at a discharge pressure) of the compressor 10 via the discharge passage 92. A discharge valve assembly 93 may be disposed within or adjacent the discharge passage 92 to allow fluid flow from the discharge pocket to the discharge chamber 38 and restrict or prevent fluid flow in the opposite direction. Pockets intermediate the first and second pockets (pockets 96, 98, 100, 102) may form intermediate compression pockets operating at intermediate pressures between the suction pressure and the discharge pressure.

Referring to FIGS. 1-4, the end plate 84 of the non-orbiting scroll 70 may include a biasing passage 110 and one or more modulation ports 112. The biasing passage 110 and modulation ports 112 may extend through the end plate 84 and may each be in fluid communication with intermediate compression pockets (e.g., pockets 96, 98, 100, 102). The biasing passage 110 may be in fluid communication with one of the intermediate compression pockets operating at a higher pressure than ones of intermediate compression pockets in fluid communication with the modulation ports 112. The biasing passage 110 may be disposed radially inward relative to the modulation ports 112.

The annular hub 88 may include first and second portions 116, 118 forming a stepped region 120 therebetween. The first portion 116 may be located axially between the second portion 118 and the end plate 84 and may have an outer diametrical surface having a diameter that is greater than a diameter of an outer diametrical surface of the second portion 118. The biasing passage 110 may extend through the annular hub 88 (e.g., through the first portion 116 and the stepped region 120).

The capacity-modulation assembly 28 may include a modulation-valve ring 126, a modulation-lift ring 128, and a modulation-control-valve assembly 132. The modulation-valve ring 126 may include an inner radial surface 134, an outer radial surface 136, an upper rim 137, and a lower axial end surface 138 defining an annular recess 140. The inner radial surface 134 may include first and second portions 148, 150. An axially upwardly facing surface 152 (i.e., a surface facing an axial direction parallel to a rotational axis of the driveshaft 62) may be disposed between the first and second portions 148, 150. The first portion 148 may have diameter that is less than a diameter of the second portion 150. The modulation-valve ring 126 may encircle the hub 88 of the non-orbiting scroll 70 such that the first portion 116 of the hub 88 is sealingly engaged (via seal 154) with the modulation-valve ring 126.

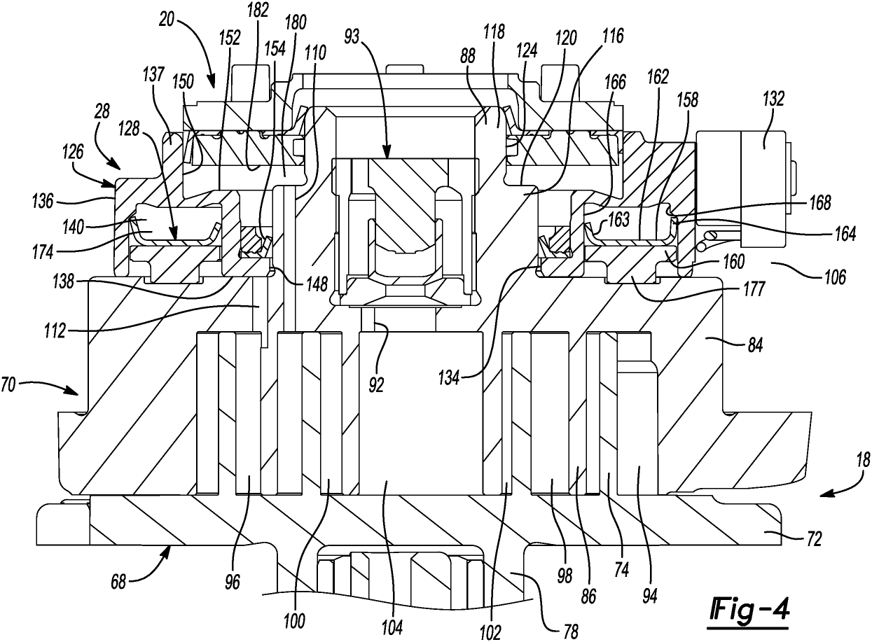

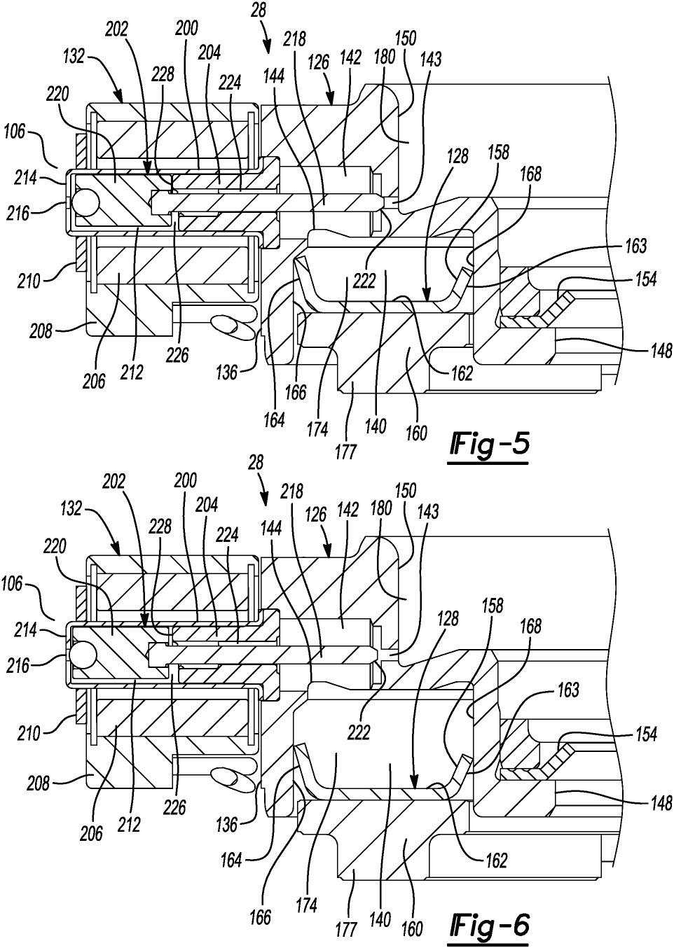

As shown in FIGS. 5 and 6, the modulation-valve ring 126 may include a first passage 142, a second passage 143, and a third passage 144. The first passage 142 is in fluid communication with the third passage 144 and is in selective fluid communication with the second passage 143.

The modulation-lift ring 128 may be located within the annular recess 140 and may include an annular seal body 158 and a base ring 160. The modulation-valve ring 126 and the modulation-lift ring 128 may cooperate to define a modulation-control chamber 174 disposed within the recess 140. The first passage 142 may be in fluid communication with modulation-control chamber 174 (via the third passage 144). The base ring 160 may support the seal body 158 and may include a series of bosses or protrusions 177 contacting the end plate 84 and defining radial flow passages 178 between the end plate 84 and the base ring 160. The base ring 160 can be formed from a metallic material, such as cast iron, for example.

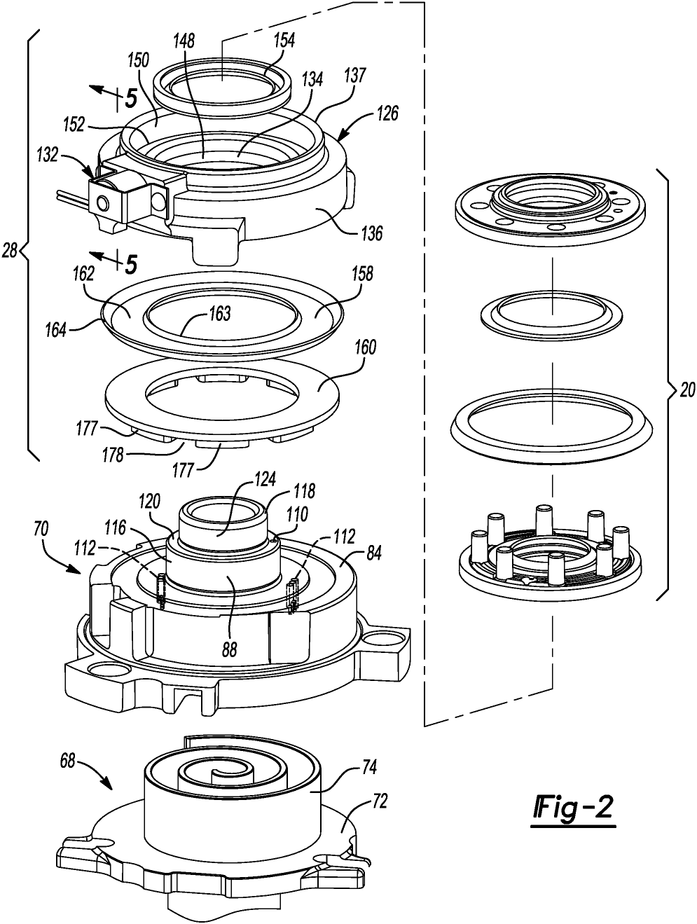

The seal body 158 may be a single, unitary body formed from a polymeric material, such as Teflon®, for example. The seal body 158 may include a generally U-shaped cross section having a base portion 162, an inner lip 163 and an outer lip 164. The lips 163, 164 may be integrally formed with the base portion 162. The base portion 162 may be a generally flat, annular member that extends radially (i.e., in a direction perpendicular to the rotational axis of the driveshaft 62). The inner lip 163 may extend from a radially inner edge of the base portion 162, and the outer lip 164 may extend from a radially outer edge of the base portion 162. The inner lip 163 may extend from the base portion 162 axially upward (i.e., toward the seal assembly 20) and radially inward (i.e., toward the hub 88). The outer lip 164 may extend from the base portion 162 axially upward (i.e., toward the seal assembly 20) and radially outward (i.e., away from the hub 88). The lips 163, 164 may be sealingly engaged with respective sidewalls 166, 168 of the annular recess 140. Fluid pressure within the modulation-control chamber 174 may force the lips 163, 164 into sealing contact with the sidewalls 166, 168 and keep the seal body 158 stationary while the modulation-valve ring 126 moves between the positions shown in FIGS. 2 and 3.

In some configurations, the modulation-lift ring 128 can be a single, unitary body. For example, the seal body 158 and the base ring 160 could be integrally formed as a single unitary body. Alternatively, the base ring 160 could be integrally formed with the end plate 84 of the non-orbiting scroll 70. The modulation-lift ring 128 could be configured similarly or identically to any of the lift rings disclosed in Assignee’s commonly owned U.S. Patent No. 8,585,382 or U.S. Patent No. 10,087,936, the disclosures of which are incorporated by reference.

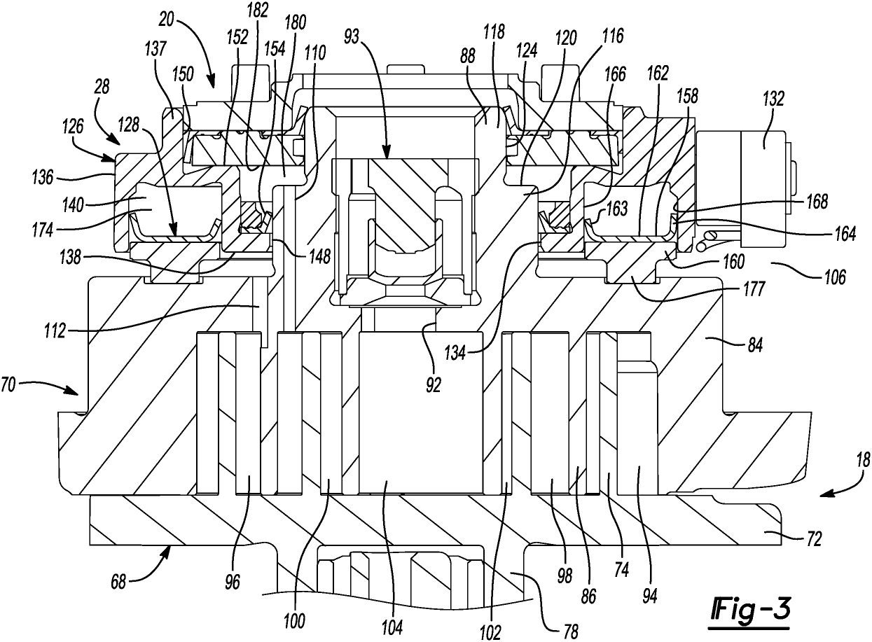

The seal assembly 20 may be a floating seal assembly and may be sealingly engaged with the non-orbiting scroll 70 and the modulation-valve ring 126 to define an axial-biasing chamber 180 (FIGS. 3 and 4) that communicates with the biasing passage 110. More specifically, the seal assembly 20 may be sealingly engaged with an outer diametrical surface 124 of the annular hub 88 and the second portion 150 of the modulation-valve ring 126. The axial-biasing chamber 180 may be defined axially between a lower axial end surface 182 of the seal assembly 20 and the axially upwardly facing surface 152 of the modulation-valve ring 126 and the stepped region 120 of the annular hub 88. The second passage 143 of the modulation-valve ring 126 may be in fluid communication with the axial-biasing chamber 180.

For example, the seal assembly 20 could be configured similarly or identically to any of the lift rings disclosed in Assignee’s commonly owned U.S. Patent No. 8,932,036 or U.S. Patent No. 10,975,868, the disclosures of which are incorporated by reference.

As shown in FIGS. 5-9, the modulation-control-valve assembly 132 may be mounted to the modulation-valve ring 126. The modulation-control-valve assembly 132 may be in fluid communication with the suction-pressure region 106 and the first, second and third passages 142, 143, 144 in the modulation-valve ring 126. During operation of the compressor 10, the modulation-control-valve assembly 132 may be movable between a first position (FIG. 5) and a second position (FIG. 6) to switch the compressor 10 between the full-capacity mode (in which the modulation-valve ring 126 closes off the modulation ports 112 to prevent fluid communication between the modulation ports 112 and the suction-pressure region 106; shown in FIG. 4) and the reduced-capacity mode (in which the modulation-valve ring 126 opens the modulation ports 112 to allow fluid communication between the modulation ports 112 and the suction-pressure region 106; shown in FIG. 3).

When the modulation-control-valve assembly 132 is in the first position (FIG. 5), the modulation-control-valve assembly 132 provides fluid communication between the modulation-control chamber 174 and the suction-pressure region 106 and prevents fluid communication between the modulation-control chamber 174 and the axial-biasing chamber 180, which causes the modulation-valve ring 126 to be forced downward into contact with the end plate 84 to close off the modulation ports 112 (as shown in FIG. 4) to prevent fluid communication between the modulation ports 112 and the suction-pressure region 106. When the modulation-control-valve assembly 132 is in the second position (FIG. 6), the modulation-control-valve assembly 132 prevents fluid communication between the modulation-control chamber 174 and the suction-pressure region 106 and provides fluid communication between the modulation-control chamber 174 and the axial-biasing chamber 180, which causes the modulation-valve ring 126 to be forced upward and away from the end plate 84 to open the modulation ports 112 (as shown in FIG. 3) to provide fluid communication between the modulation ports 112 and the suction-pressure region 106.

The modulation-control-valve assembly 132 may be a solenoid valve assembly, for example. As shown in FIGS. 5-9, the modulation-control-valve assembly 132 may include a valve body 200, a valve member 202, a plug body 204, a solenoid coil 206, a coil housing 208, and a mounting bracket 210. The valve body 200 may be a generally cylindrical and hollow body defining an internal cavity 212. A first axial end surface 214 of the valve body 200 may include an aperture 216 that provides fluid communication between the suction-pressure region 106 and the internal cavity 212. The opposite axial end (i.e., the axial end opposite the first axial end surface 214) of the valve body 200 is open such that the valve body 200 and the plug body 204 can be received therethrough.

The valve member 202 may include a stem 218 and a block 220. The block 220 may be slidably received within the internal cavity 212 of the valve body 200. The stem 218 may be an elongated pin or rod that extends from an end of the block 220. The stem 218 extends through the open axial end of the valve body 200 and extends into the first passage 142 in the modulation-valve ring 126. The stem 218 is fixed to the block 220 and is movable with the block 220. In some configurations, the stem 218 and the block 220 could be integrally formed as a single, unitary body. When the modulation-control-valve assembly 132 is in the first position (FIG. 5), the block 220 is spaced apart from the aperture 216 (to allow fluid communication between the internal cavity 212 and the suction-pressure region 106 via the aperture 216) and a distal end 222 of the stem 218 plugs or closes off the second passage 143 in the modulation-valve ring 126 (to prevent fluid communication between the axial-biasing chamber 180 and the first and third passages 142, 144). When the modulation-control-valve assembly 132 is in the second position (FIG. 6), the block 220 plugs or closes off the aperture 216 (to prevent fluid communication between the internal cavity 212 and the suction-pressure region 106 via the aperture 216) and the distal end 222 of the stem 218 is spaced apart from the second passage 143 (to allow fluid communication between the axial-biasing chamber 180 and the modulation-control chamber 174 via the first, second, and third passages 142, 143, 144).

The plug body 204 may be a cylindrical body that is fixedly received in the internal cavity 212 of the valve body 200. The plug body 204 may include a passage 224 through which the stem 218 extends. The diameters of the stem 218 and the passage 224 may be sized such that working fluid can flow through the passage 224 around the stem 218. The passage 224 is in fluid communication with the first passage 142 and is in fluid communication with the internal cavity 212 via an aperture 226 (FIGS. 5 and 6) formed in an axial end 228 of the plug body 204.

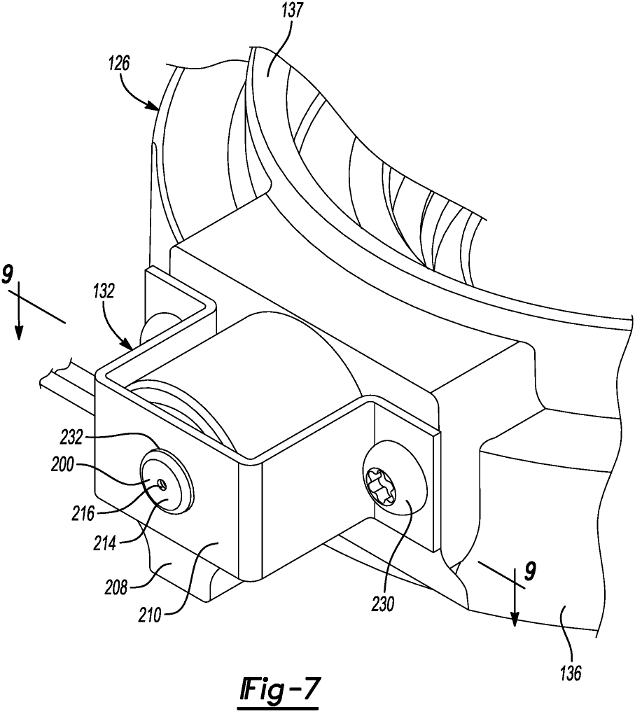

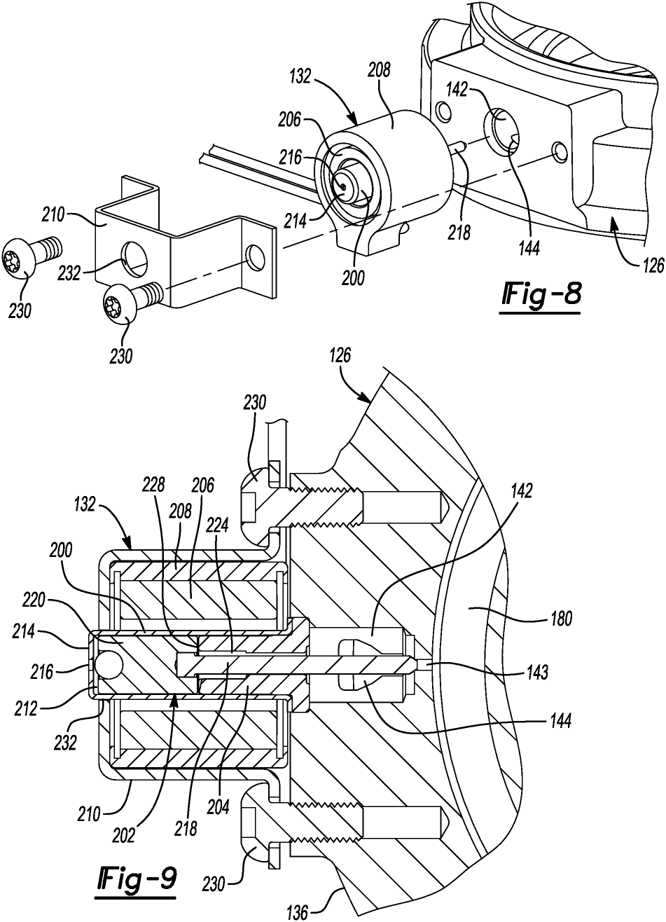

The solenoid coil 206 may be disposed within the coil housing 208 and may surround the valve member 202 and the valve body 200. The solenoid coil 206 may be electrically connected to a source of electrical power. The solenoid coil 206 and coil housing 208 are fixed relative to the valve body 200. The valve body 200 may be at least partially disposed within the coil housing 208. The valve member 202 is disposed partially within the coil housing 208 and extends out of the coil housing 208 and into the first passage 142 of the modulation-valve ring 126. The coil housing 208 may be fixed to the modulation-valve ring 126 by the mounting bracket 210 and fasteners 230. The first axial end surface 214 of the valve body 200 may extend through an aperture 232 in the mounting bracket 210 (FIGS. 8 and 9).

The mounting bracket 210, the block 220 of the valve member 202, the plug body 204, and the modulation-valve ring 126 may be formed from (or include portions formed from) one or more magnetic materials (e.g., steel or iron) such that the mounting bracket 210, the block 220 of the valve member 202, the plug body 204, and the modulation-valve ring 126 cooperate with each other to complete a magnetic flux circuit when the solenoid coil 206 is energized. Energizing the solenoid coil 206 causes the block 220 of the valve member 202 to be magnetically attracted to the plug body 204, thereby causing the valve member 202 to move to the first position (FIG. 5) in which the stem 218 of the valve member 202 closes off the second passage 143 to prevent fluid communication between the axial-biasing chamber 180 and the modulation-control chamber 174. Moving the valve member 202 to the first position also opens the aperture 216 to allow fluid communication between the modulation-control chamber 174 and the suction-pressure region 106. This lowers the fluid pressure within the modulation-control chamber 174 to suction pressure. With the fluid pressure within the modulation-control chamber 174 at or near suction pressure, the relatively higher fluid pressure within the axial-biasing chamber 180 will force the modulation-valve ring 126 axially downward into contact with the end plate 84 such that the lower axial end surface 138 of the modulation-valve ring 126 closes the modulation ports 112 (as shown in FIG. 4), thereby causing compressor 10 to operate in the high-capacity mode.

To operate the compressor 10 in the reduced-capacity mode, the solenoid coil 206 can be de-energized to eliminate the magnetic attraction between the plug body 204 and the block 220 of the valve member 202. With the solenoid coil 206 de-energized, pressure from fluid in the axial-biasing chamber 180 may force the valve member to the second position (FIG. 6) in which the stem 218 of the valve member 202 opens the second passage 143 to allow fluid communication between the axial-biasing chamber 180 and the modulation-control chamber 174. In some configurations, the modulation-control-valve assembly 132 may include a spring that urges the valve member 202 toward the second position. Moving the valve member 202 to the second position also closes the aperture 216 to prevent fluid communication between the modulation-control chamber 174 and the suction-pressure region 106. When the valve member 202 is in the second position, fluid communication between the modulation-control chamber 174 and the axial-biasing chamber 180 via the second passage 143 raises the fluid pressure within the modulation-control chamber 174 to the same or similar intermediate pressure as the axial-biasing chamber 180 and the intermediate pocket in communication with the axial-biasing chamber 180 via the biasing passage 110. With the fluid pressure within the modulation-control chamber 174 at the same intermediate pressure as the axial-biasing chamber 180, the fluid pressure within the modulation-control chamber 174 will force the modulation-valve ring 126 axially upward relative to the end plate 84 such that the lower axial end surface 138 of the modulation-valve ring 126 is spaced apart from the end plate 84 to open the modulation ports 112 (as shown in FIG. 3) to allow fluid communication between one or more of the intermediate-pressure compression pockets 96, 98 and the suction-pressure region 106 via the modulation ports 112.

The modulation-control-valve assembly 132 of the present disclosure has several advantages over prior-art valve assemblies. For example, the modulation-control-valve assembly 132 can be connected directly to the modulation-valve ring 126 such that a manifold is not needed to fluidly couple the modulation-control-valve assembly 132 to the modulation-valve ring 126. Furthermore, the third passage 144 may act as a debris trap allowing any debris from the axial-biasing chamber 180 to flow into the modulation-control chamber 174 rather than into the modulation-control-valve assembly 132. In this manner, the modulation-control-valve assembly 132 debris may be prevented from binding the modulation-control-valve assembly 132 without the use of a debris filter.

In some configurations, there may be only a very small clearance (for example, about 55 microns) in the passage 224 between the stem 218 and the plug body 204. This very small clearance may create resistance to the flow of debris toward the internal cavity 212 of the valve body 200. Instead, this resistance to the flow of debris may cause the debris to flow through the third passage 144 and into the modulation-control chamber 174.

Referring now to FIG. 10, another modulation-control-valve assembly 332 is provided. The modulation-control-valve assembly 332 may be incorporated into the compressor 10 instead of the modulation-control-valve assembly 132. The structure and function of the modulation-control-valve assembly 332 may be similar or identical to that of the modulation-control-valve assembly 132 described above, apart from differences described below.

Like the modulation-control-valve assembly 132, the modulation-control-valve assembly 332 may include a valve body 400, a valve member 402, a plug body 404, a solenoid coil 406, a coil housing 408, and a mounting bracket 410. The valve body 400, valve member 402, solenoid coil 406, coil housing 408, and mounting bracket 410 may be similar or identical to the valve body 200, valve member 202, solenoid coil 206, coil housing 208, and mounting bracket 210.

As shown in FIG. 10, the plug body 404 may be similar or identical to the plug body 204, except the plug body 404 may include a tapered end 405 that extends into the first passage 142 of the modulation-valve ring 126. Passage 424 (through which a stem 418 of valve member 402 extends) may extend through the tapered end 405 and through the entire axial length of the plug body 404. The stem 418 protrudes out of the distal tip of the tapered end 405. An outer diameter of the tapered end 405 decreases as the tapered end 405 extends toward the second passage 143 of the modulation-valve ring 126. For example, the tapered end 405 may have a generally conical (or frustoconical) shape, a hemispherical shaped, a paraboloid shape, or a hyperboloid shape. The tapered end 405 of the plug body 404 helps to deflect debris away from the passage 424 and the interior of the modulation-control-valve assembly 332 and towards the third passage 144 and the modulation-control chamber 174.

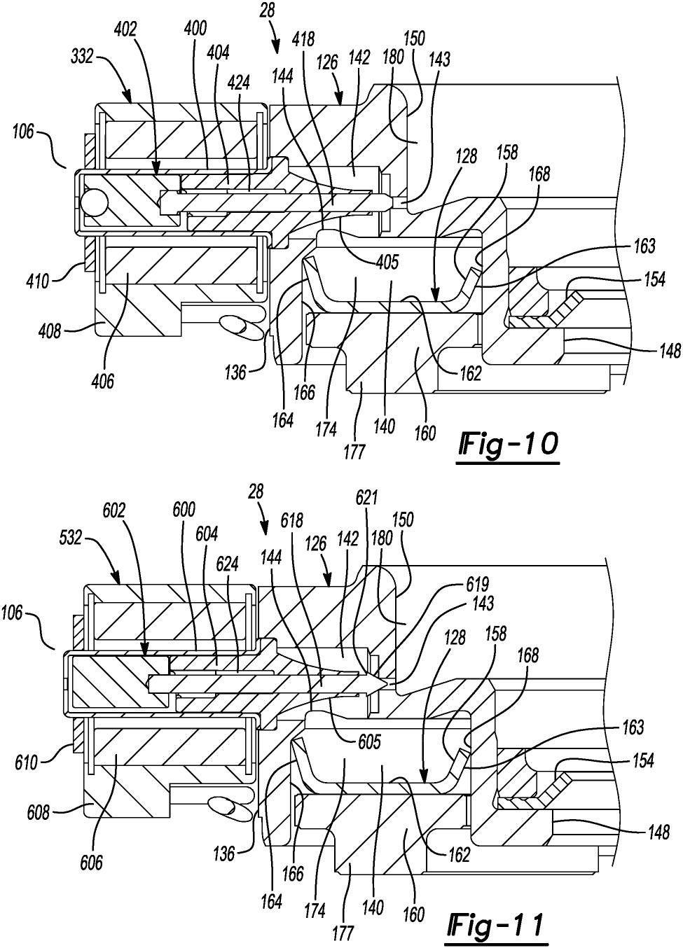

Referring now to FIG. 11, another modulation-control-valve assembly 532 is provided. The modulation-control-valve assembly 532 may be incorporated into the compressor 10 instead of the modulation-control-valve assembly 132, 332. The structure and function of the modulation-control-valve assembly 532 may be similar or identical to that of the modulation-control-valve assembly 332 described above, apart from differences described below.

Like the modulation-control-valve assembly 132, 332, the modulation-control-valve assembly 532 may include a valve body 600, a valve member 602, a plug body 604, a solenoid coil 606, a coil housing 608, and a mounting bracket 610. Stem 618 of the valve member 602 may include a barbed distal tip 619. The barbed distal tip 619 may be tapered such that it defines a shoulder or stop member 621 that abuts a distal tip of a tapered end 605 of the plug body 604 when the modulation-control-valve assembly 532 is in a position corresponding to the reduced-capacity mode. The barbed distal tip 619 may be tapered to plug the second passage 143 when the modulation-control-valve assembly 532 is in a position corresponding to the high-capacity mode. The barbed distal tip 619 of the stem 618 helps to deflect debris away from passage 624 and the interior of the modulation-control-valve assembly 532 and towards the third passage 144 and the modulation-control chamber 174.

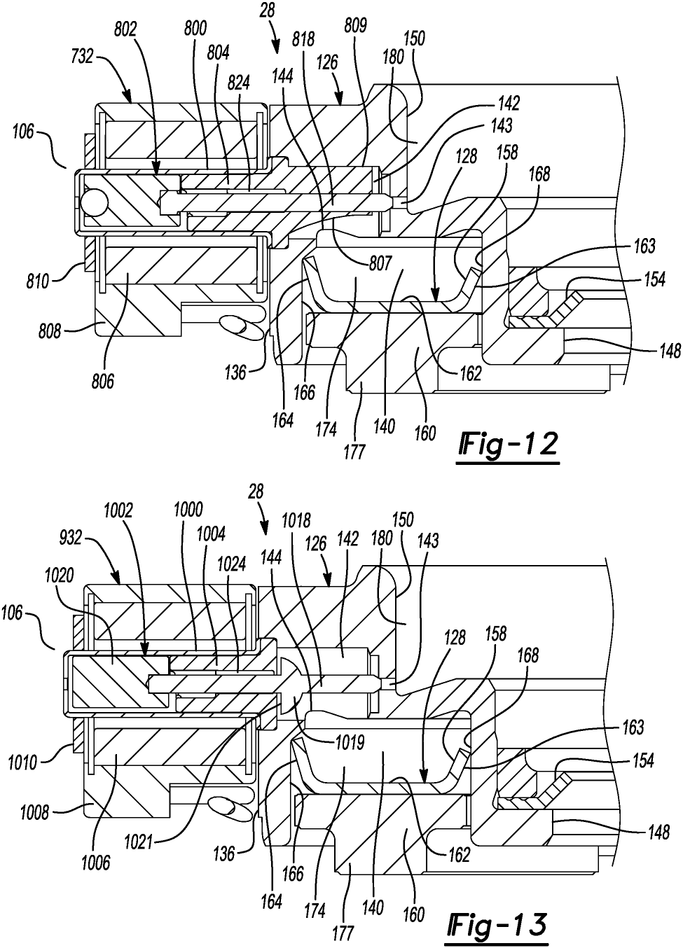

Referring now to FIG. 12, another modulation-control-valve assembly 732 is provided. The modulation-control-valve assembly 732 may be incorporated into the compressor 10 instead of the modulation-control-valve assembly 132, 332, 532. The structure and function of the modulation-control-valve assembly 732 may be similar or identical to that of the modulation-control-valve assembly 332, 532 described above, apart from differences described below.

Like the modulation-control-valve assembly 132, the modulation-control-valve assembly 732 may include a valve body 800, a valve member 802, a plug body 804, a solenoid coil 806, a coil housing 808, and a mounting bracket 810. The valve body 800, valve member 802, solenoid coil 806, coil housing 808, and mounting bracket 810 may be similar or identical to the valve body 200, valve member 202, solenoid coil 206, coil housing 208, and mounting bracket 210.

As shown in FIG. 12, the plug body 804 may be similar or identical to the plug body 404, except the plug body 804 may include an end 805 having a tapered portion 807 and a generally cylindrical portion 809 that extend into the first passage 142 of the modulation-valve ring 126. The cylindrical portion 809 may fill or partially fill an upper portion of the first passage 142 (e.g., a portion of the first passage 142 generally level with or above the second passage 143 and stem 818 of valve member 802). The cylindrical portion 809 may block debris from flowing toward the interior of the modulation-control-valve assembly 732. The tapered portion 807 may have a generally conical (or frustoconical) shape, a hemispherical shaped, a paraboloid shape, or a hyperboloid shape, for example. The tapered portion 807 of the plug body 804 helps to deflect debris away from passage 824 and the interior of the modulation-control-valve assembly 732 and towards the third passage 144 and the modulation-control chamber 174.

Referring now to FIG. 13, another modulation-control-valve assembly 932 is provided. The modulation-control-valve assembly 932 may be incorporated into the compressor 10 instead of the modulation-control-valve assembly 132, 332, 532, 732. The structure and function of the modulation-control-valve assembly 932 may be similar or identical to that of the modulation-control-valve assembly 132, 332, 532, 732 described above, apart from differences described below.

Like the modulation-control-valve assembly 132, the modulation-control-valve assembly 932 may include a valve body 1000, a valve member 1002, a plug body 1004, a solenoid coil 1006, a coil housing 1008, and a mounting bracket 1010. The valve body 1000, valve member 1002, plug body 1004, solenoid coil 1006, coil housing 1008, and mounting bracket 1010 may be similar or identical to the valve body 200, valve member 202, plug body 204, solenoid coil 206, coil housing 208, and mounting bracket 210 described above, apart from differences described below.

Like the valve member 202, the valve member 1002 may include a stem 1018 and a block 1020. The block 1020 can be similar or identical to the block 220. The stem 1018 can be similar or identical to the stem 218, except the stem 1018 may include a flange or deflector 1019. The deflector 1019 may extend from an intermediate portion of the stem 1018 between axial ends of the stem 1018. For example, the deflector 1019 have a generally conical (or frustoconical) shape, a hemispherical shape, a paraboloid shape, or a hyperboloid shape. The deflector 1019 helps to deflect debris away from the passage 1024 and the interior of the modulation-control-valve assembly 932 and towards the third passage 144 and the modulation-control chamber 174. The deflector 1019 may define a shoulder or stop member 1021 that abuts the plug body 1004 when the modulation-control-valve assembly 932 is in a position corresponding to the reduced-capacity mode.

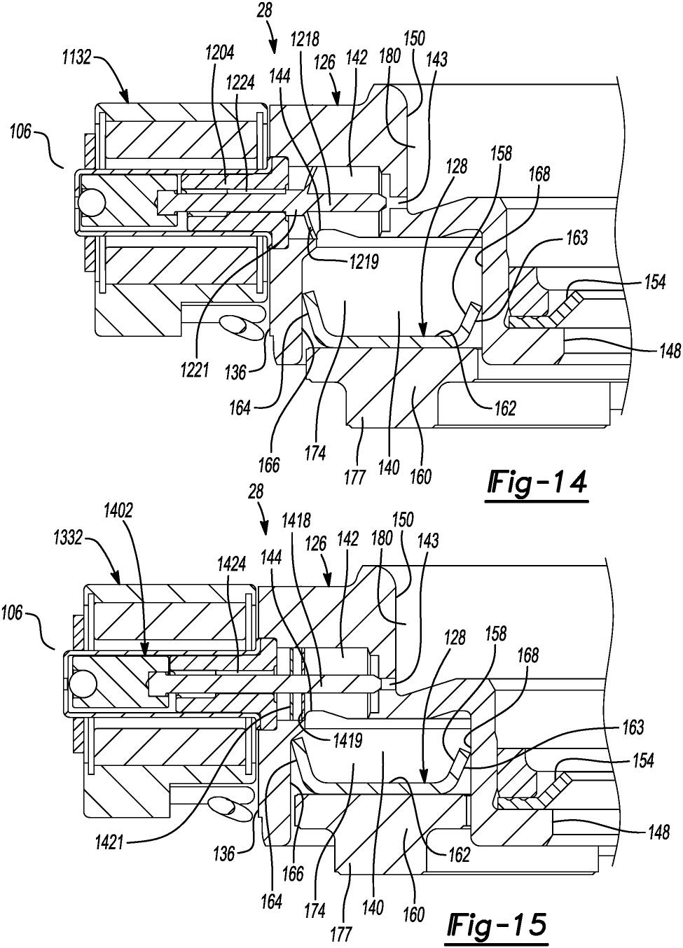

Referring now to FIG. 14, another modulation-control-valve assembly 1132 is provided. The modulation-control-valve assembly 132 may be incorporated into the compressor 10 instead of the modulation-control-valve assembly 132, 332, 532, 732, 932. The structure and function of the modulation-control-valve assembly 1132 may be similar or identical to that of the modulation-control-valve assembly 132, 332, 532, 732, 932 described above, apart from differences described below.

Like the stem 1018 described above, a stem 1218 of the modulation-control-valve assembly 1132 may include a flange or deflector 1219 with a shoulder or stop member 1221. The deflector 1219 helps to deflect debris away from the passage 1224 and the interior of the modulation-control-valve assembly 1132 and towards the third passage 144 and the modulation-control chamber 174. The shoulder 1221 abuts the plug body 1204 when the modulation-control-valve assembly 1132 is in a position corresponding to the reduced-capacity mode.

Referring now to FIG. 15, another modulation-control-valve assembly 1332 is provided. The modulation-control-valve assembly 1332 may be incorporated into the compressor 10 instead of the modulation-control-valve assembly 132, 332, 532, 732, 932, 1132. The structure and function of the modulation-control-valve assembly 1332 may be similar or identical to that of the modulation-control-valve assembly 132, 332, 532, 732, 932, 1132 described above, apart from differences described below.

A stem 1418 of the valve member 1402 of the modulation-control-valve assembly 1332 may extend through one or more screens 1419, 1421. The screens 1419, 1421 may be formed from a mesh material or a porous material, for example, that are configured to allow gas to flow through but restrict or prevent solid particles (debris) from passing through.

In some configurations, the first screen 1419 may be press fitted or otherwise fixed within the first passage 142 of the modulation-valve ring 126, and the second screen 1421 may be press fitted onto the stem 1418 and movable with the stem 1418 relative to the modulation-valve ring 126. A small clearance may exist between the first screen 1419 and the stem 1418, and another small clearance may exist between the second screen 1421 and surfaces of the modulation-valve ring 126. The clearances allow for continued gas flow into the passage 1424 even if the screens 1419, 1421 become clogged.

In other configurations, the second screen 1421 may be press fitted or otherwise fixed within the first passage 142 of the modulation-valve ring 126, and the first screen 1419 may be press fitted onto the stem 1418 and movable with the stem 1418 relative to the modulation-valve ring 126. A small clearance may exist between the second screen 1421 and the stem 1418, and another small clearance may exist between the first screen 1419 and surfaces of the modulation-valve ring 126. The clearances allow for continued gas flow into the passage 1424 even if the screens 1419, 1421 become clogged.

In either of the above configurations, the screens 1419, 1421 prevent debris from flowing into the passage 1424 and the interior of the modulation-control-valve assembly 1332 and direct the debris towards the third passage 144 and the modulation-control chamber 174.

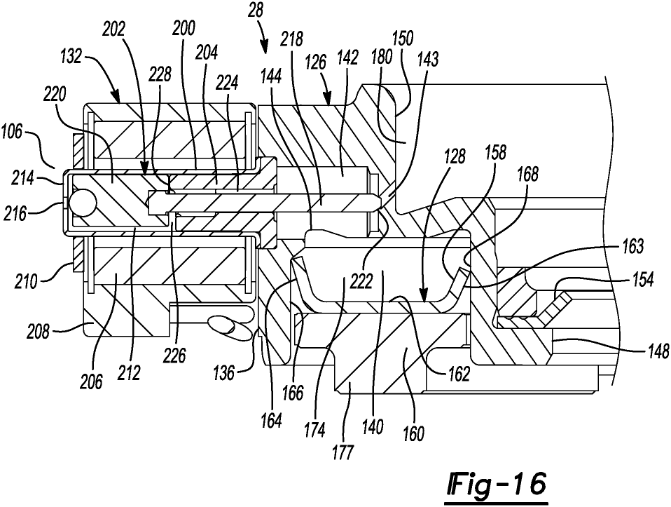

FIG. 16 shows an alternative configuration of the modulation-valve ring 126 in which the second passage 143 is angled relative to the axial length of the stem 218. That is, the second passage 143 is angled toward the third passage 144 so that any debris flowing through the second passage 143 will be directed toward the third passage 144 and the modulation-control chamber 174 rather than toward the passage 224 of the modulation-control-valve assembly 132. While FIG. 16 shows the modulation-control-valve assembly 132, it will be appreciated that any of the modulation-control-valve assemblies 132, 332, 532, 732, 932, 1132, 1332 could be used in conjunction with the angled second passage 143 shown in FIG. 16.

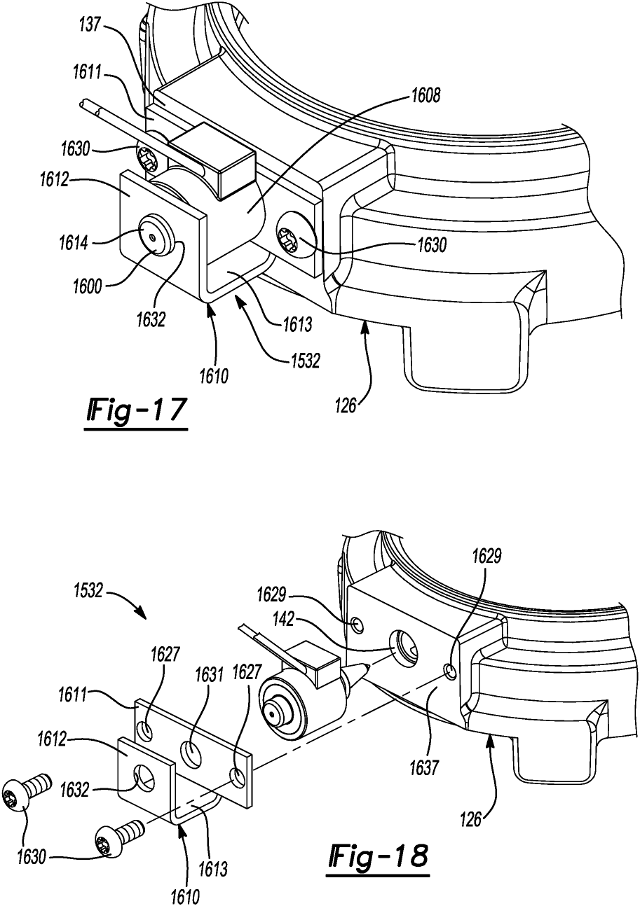

Referring now to FIGS. 17 and 18, another modulation-control-valve assembly 1532 is provided. The modulation-control-valve assembly 1532 may be incorporated into the compressor 10 instead of the modulation-control-valve assembly 132, 332, 532, 732, 932, 1132, 1332. The structure and function of the modulation-control-valve assembly 1532 may be similar or identical to that of the modulation-control-valve assembly 132, 332, 532, 732, 932, 1132, 1332 described above, apart from any differences described below and/or shown in the figures.

Like the modulation-control-valve assembly 132, 332, 532, 732, 932, 1132, 1332, the modulation-control-valve assembly 1532 is attached to the modulation-valve ring 126 via a mounting bracket 1610 and fasteners 1630.

The mounting bracket 1610 may be generally U-shaped and may include a first arm 1611, a second arm 1612, and a third arm 1613 that extends between the first and second arms 1611, 1612. The first arm 1611 may contact a surface 137 of the modulation-valve ring 126. The fasteners 1630 extend through apertures 1627 in the first arm 1611 and into threaded apertures 1629 in the modulation-valve ring 126.

The first arm 1611 may include a first aperture 1631 that is aligned with first passage 142 of the modulation-valve ring 126 to allow the plug body and stem of the modulation-control-valve assembly 1532 to extend through the first arm 1611 and into the first passage 142. A first axial end surface 1614 of a valve body 1600 may extend through a second aperture 1632 in the second arm 1612 of the mounting bracket 1610. A coil housing 1608 of the modulation-control-valve assembly 1532 may be disposed between the first and second arms 1611, 1612. The mounting bracket 1610 may be formed from a metallic material, for example. As described above, the mounting bracket 1610, the modulation-valve ring 126, and other components of the modulation-control-valve assembly 1532 cooperate to complete a magnetic flux circuit when the solenoid coil of the modulation-control-valve assembly 1532 is energized.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A compressor comprising:
a shell assembly defining a suction-pressure region and a discharge-pressure region, the shell assembly including a partition separating the suction-pressure region from the discharge-pressure region;
a first scroll disposed within the shell assembly and including a first end plate having a discharge passage, a modulation port, a biasing passage, and a first spiral wrap extending from the first end plate;
a second scroll disposed within the shell assembly and including a second end plate having a second spiral wrap extending therefrom, the first and second spiral wraps meshingly engaged and forming a series of pockets during orbital displacement of the second scroll relative to the first scroll, the modulation port in communication with a first one of the pockets, the biasing passage in communication with a second one of the pockets;
a floating seal assembly engaged with the partition and the first scroll and isolating the discharge-pressure region from the suction-pressure region;
a modulation-valve ring located axially between the floating seal assembly and the first end plate, the modulation-valve ring cooperating with the floating seal assembly and a hub extending from the first end plate to define an axial-biasing chamber in fluid communication with the biasing passage, the modulation-valve ring being axially displaceable between a closed position and an open position, the modulation-valve ring abutting the first end plate and closing the modulation port when in the closed position, the modulation-valve ring being spaced apart from the first end plate to open the modulation port when in the open position; and
a modulation-control-valve assembly mounted to the modulation-valve ring and movable between a first position corresponding to the closed position and a second position corresponding to the open position,
wherein the modulation-valve ring includes a first passage, a second passage, and a third passage,
wherein the second passage is in fluid communication with the axial-biasing chamber,
wherein the third passage is in fluid communication with a modulation-control chamber defined by the modulation-valve ring,
wherein the first passage provides fluid communication between the second and third passages when the modulation-control-valve assembly is in the second position,
wherein the modulation-control-valve assembly includes a valve body, a valve member, and a plug body,
wherein the valve body and the plug body are fixed relative to the modulation-valve ring,
wherein the valve member is partially disposed within the valve body and movable therein between the first and second positions,
wherein a first portion of the valve member extends through the plug body and into the first passage, and
wherein the plug body is partially disposed within the valve body and extends out of the valve body and into the first passage.

2. The compressor of claim 1, wherein in the first position, the modulation-control-valve assembly prevents fluid communication between the second and third passages and allows fluid communication between the modulation-control chamber and the suction-pressure region.

3. The compressor of claim 2, wherein in the first position, the modulation-control-valve assembly allows fluid communication between the modulation-control chamber and the suction-pressure region via the third passage, the first passage, and an aperture in a valve body of the modulation-control-valve assembly.

4. (canceled)

5. The compressor of claim 1, wherein:
the first portion of the valve member closes the second passage when the modulation-control-valve assembly is in the first position,
a second portion of the valve member closes an aperture in the valve body when the modulation-control-valve assembly is in the second position, and
the valve member allows fluid communication between the modulation-control chamber and the suction-pressure region through the aperture when the modulation-control-valve assembly is in the first position.

6. The compressor of claim 5, wherein:
the modulation-control-valve assembly includes a coil that extends around the valve body, and
energizing the coil causes the second portion of the valve member to be magnetically attracted to the plug body, which causes movement of the valve member toward the first position.

7. The compressor of claim 6, wherein the first portion of the valve member includes a deflector configured to direct debris into the modulation-control chamber.

8. The compressor of claim 6, wherein the first portion of the valve member extends through a screen that restricts the flow of debris into the modulation-control-valve assembly.

9. The compressor of claim 6, wherein the plug body includes a tapered end portion configured to direct debris into the modulation-control chamber.

10. The compressor of claim 6, wherein the first portion of the valve member includes a barbed tip that closes the second passage when the modulation-control-valve assembly is in the first position.

11. The compressor of claim 6, wherein the second passage is angled relative to an axial length of the first portion of the valve member.

12. The compressor of claim 1, wherein when the modulation-control-valve assembly is in the second position, fluid flows from the axial-biasing chamber to the modulation-control chamber without flowing through the modulation-control-valve assembly.

13. The compressor of claim 12, wherein when the modulation-control-valve assembly is in the first position, fluid flows through the modulation-control-valve assembly from the modulation-control chamber to the suction-pressure region.

14. A compressor comprising:
a shell assembly defining a suction-pressure region;
a first scroll disposed within the shell assembly and including a first end plate having a discharge passage, a modulation port, a biasing passage, and a first spiral wrap extending from the first end plate;
a second scroll disposed within the shell assembly and including a second end plate having a second spiral wrap extending therefrom, the first and second spiral wraps meshingly engaged and forming a series of pockets, the modulation port in communication with a first one of the pockets, the biasing passage in communication with a second one of the pockets;
a floating seal assembly engaged with the first scroll and isolating the suction-pressure region from discharge-pressure working fluid;
a modulation-valve ring engaging the first scroll and cooperating with the floating seal assembly and the first scroll to define an axial-biasing chamber in fluid communication with the biasing passage, the modulation-valve ring being axially displaceable between a closed position and an open position, the modulation-valve ring abutting the first end plate and closing the modulation port when in the closed position, the modulation-valve ring being spaced apart from the first end plate to open the modulation port when in the open position; and
a modulation-control-valve assembly mounted to the modulation-valve ring and movable between a first position corresponding to the closed position and a second position corresponding to the open position,
wherein the modulation-valve ring includes a first passage, a second passage, and a third passage,
wherein the second passage is in fluid communication with the axial-biasing chamber,
wherein the third passage is in fluid communication with a modulation-control chamber defined by the modulation-valve ring,
wherein the first passage provides fluid communication between the second and third passages when the modulation-control-valve assembly is in the second position,
wherein the modulation-control-valve assembly includes a valve body, a valve member, and a plug body,
wherein the valve body and the plug body are fixed relative to the modulation-valve ring,
wherein the valve member is partially disposed within the valve body and movable therein between the first and second positions,
wherein a first portion of the valve member extends through the plug body and into the first passage, and
wherein, the plug body is partially disposed within the valve body and extends out of the valve body and into the first passage.

15. The compressor of claim 14, wherein when the modulation-control-valve assembly is in the second position, fluid flows from the axial-biasing chamber to the modulation-control chamber without flowing through the modulation-control-valve assembly.

16. The compressor of claim 15, wherein when the modulation-control-valve assembly is in the first position:
fluid flows through the modulation-control-valve assembly from the modulation-control chamber to the suction-pressure region, and
the modulation-control-valve assembly prevents fluid communication between the second and third passages.

17. (canceled)

18. The compressor of claim 16, wherein:
the first portion of the valve member closes the second passage when the modulation-control-valve assembly is in the first position,
a second portion of the valve member closes an aperture in the valve body when the modulation-control-valve assembly is in the second position, and
the valve member allows fluid communication between the modulation-control chamber and the suction-pressure region through the aperture when the modulation-control-valve assembly is in the first position.

19. The compressor of claim 18, wherein:
the modulation-control-valve assembly includes a coil that extends around the valve body, and
energizing the coil causes the second portion of the valve member to be magnetically attracted to the plug body, which causes movement of the valve member toward the first position.

20. A compressor comprising:
a shell assembly defining a suction-pressure region;
a first scroll disposed within the shell assembly and including a first end plate having a discharge passage, a modulation port, a biasing passage, and a first spiral wrap extending from the first end plate;
a second scroll disposed within the shell assembly and including a second end plate having a second spiral wrap extending therefrom, the first and second spiral wraps meshingly engaged and forming a series of pockets, the modulation port in communication with a first one of the pockets, the biasing passage in communication with a second one of the pockets;
a floating seal assembly engaged with the first scroll and isolating the suction-pressure region from discharge-pressure working fluid;
a modulation-valve ring engaging the first scroll and cooperating with the floating seal assembly and the first scroll to define an axial-biasing chamber in fluid communication with the biasing passage, the modulation-valve ring being axially displaceable between a closed position and an open position, the modulation-valve ring abutting the first end plate and closing the modulation port when in the closed position, the modulation-valve ring being spaced apart from the first end plate to open the modulation port when in the open position, the modulation-valve ring defining a modulation-control chamber; and
a modulation-control-valve assembly mounted to the modulation-valve ring and movable between a first position corresponding to the closed position and a second position corresponding to the open position,
wherein when the modulation-control-valve assembly is in the second position, fluid flows from the axial-biasing chamber to the modulation-control chamber without flowing through the modulation-control-valve assembly,
wherein the modulation-control-valve assembly includes a valve body, a valve member, and a plug body,
wherein the valve body and the plug body are fixed relative to the modulation-valve ring,
wherein the valve member is partially disposed within the valve body and movable therein between the first and second positions,
wherein a first portion of the valve member extends through the plug body and into the first passage, and
wherein the plug body is partially disposed within the valve body and extends out of the valve body and into a first passage formed in the modulation-valve ring.
